(19) United States
(12) Patent Application Publication
(10) Pub. No.: US 2002/0057365 A1
(43) Pub. Date: May 16, 2002

(54) Monitoring or security device and methods

(75) Inventor: Louis A. Brown, Toledo, OH (US)

Correspondence Address: Robert J. Clark, Oldham & Oldham Co., L.P.A., Twin Oaks Estate, 1225 W. Market Street, Akron, OH, 44313, US

(73) Assignee: Logical Services, Inc.

(21) Appl. No.: 09/839,181

(22) Filed: Apr. 19, 2001

Related U.S. Application Data
(60) Provisional application No. 60/198,417, filed on Apr. 19, 2000.

(51) Int. Cl. H04N 7/00

(52) U.S. Cl. 348/552

(57) ABSTRACT

A portable, hand-held, electronically powered security device is disclosed. The device is comprised of a contoured outer housing having an elongated handle and a spherical head portion. The handle and head may be provided with features that facilitate use in a variety of environments, and may include a flashlight, a video camera, a pepper spray storage and dispensing mechanism, and/or a radio frequency transmitter-receiver as examples, all of which are positioned within the outer housing. The handle is provided with a number of manually operated switches, including an ON/OFF switch, an audio transmit switch, a flashlight switch, a camera switch and an infrared switch. The handle is further provided with an outwardly projecting antenna. The head accommodates various operating elements of the devices housed therewithin. Such operating elements may include: a flashlight lens, a video camera lens, a liquid crystal display monitor, a pepper spray outlet, a laser beam generator and even LED infrared illuminators, used in conjunction with the video camera so that the device has “night-vision” capabilities. The device of the present invention provides wireless audio and video communication between itself and a remotely located control center or other receiver. The control center is manned by a person who, upon receipt of an alert or distress call from the user, can ascertain the nature of the event that prompted the call, quickly determine what responsive action is necessary and muster all resources required to effectively respond. The system can also be utilized to monitor other camera locations that are connected to the control center. Environments in which it is believed that device of the present invention can have applications include the home, commercial and industrial establishments, law enforcement agencies and the military.

### FIELD OF THE INVENTION

The present invention relates generally to portable monitoring or security devices, and more particularly, to monitoring or security devices and methods for enhancing security patrol procedures in a facility or other environment. The device and method of the present invention provide remote monitoring capabilities, such as by means of a hand held device. The device may comprise a video camera, audio microphone or other monitoring components, and a communication system for transmission and/or reception of video and/or audio signals. In a method according to the invention, the video and/or audio information obtained by the device may be transmitted to a central location, such as a network operation or command center or the like, or to other devices, to provide remote monitoring capabilities in a security operation or for other purposes. The device may also include a light source, an infrared illumination source to facilitate operation of the camera in the dark, a laser source for locating, controlling video operation or communicating data, a pepper spray (or mace or the like) personal protection feature and other desirable features.

### BACKGROUND OF THE INVENTION

Compact, mobile electronic devices for use in a variety of security and emergency situations are known. Thus far, such devices have been capable of sending, via radio waves and similar means, an alarm signal to a centrally located monitoring or surveillance center when a security breach or an event causing personal injury, death and/or property damage has occurred. Some of these known devices have also been capable of providing two-way voice communication between a person possessing the device and yet another person manning the monitoring center.

While the above described known devices have functioned to communicate the existence of situations and to prompt action responsive to them, a need for a device having enhanced capabilities exists. It would be desirable to allow better communication as to events or situations from a remote site to a central location to better respond or to better tailor the responsive action to a particular situation. It would also be desirable to provide a tool which enhances the capabilities or resources available to a user to respond appropriately for given circumstances or environments. For example, it would be desirable to outfit security patrol personnel with a tool which provides multiple capabilities and benefits to promote safety and use to better deal with security or like issues. By providing video communication, more comprehensive information can be conveyed about an event or situation being reported to the monitoring station and a better response to the event can be planned and carried out. It is further envisioned that by supplying the user with other tools, such as self-defense protection, the user will be able to better respond to or handle situations which may arise.

### SUMMARY OF THE INVENTION

It is therefore an object of the present invention to provide an apparatus which overcomes the limitations or prior devices and facilitates better communication from a remote site to a central location regarding security or like problems or situations. In part the present invention is directed to incorporating a means for video communication between a hand-held device and a central site, such as a network operating center, or with other of the inventive devices.

The present invention is directed to a portable, hand-held, electronically powered security device comprised of an ergonomically contoured outer housing having an elongated handle portion and a head portion. The handle and head portions of the outer housing are provided with a variety of user interfaces to features that facilitate operation of a flashlight, a laser light, a video camera, a pepper spray storage and dispensing mechanism, an audio/video transceiver, and a communication system or other components, all of which are housed within the outer housing. The handle portion is provided with a number of manually operated switches, including an on/off switch, an audio transmit switch, a flashlight switch, a camera switch and an infrared switch. An external or internal built-in RF antenna or other wireless communication components are provided in conjunction with the housing. The head portion of the outer housing is provided with a collection of apertures which accommodate various operating elements of the devices housed therewithin. Such operating elements may include: a flashlight lens, a video camera lens, a liquid crystal display monitor, a pepper spray outlet, a radiation emitting end of a laser, LED illuminators of an infrared radiation source and/or a GPS system to locate the device and user.

The device of the present invention, in addition to being usable as a flashlight and as a self defense device, provides wireless audio and/or video communication between itself and a remotely located network operating center which communicates with a plurality of the devices, or between other of the inventive devices. The network operating or control center or another user of a device, upon receipt of an alert or distress call from a user of the device, can ascertain the nature of the event that prompted the call, quickly determine what responsive action is necessary and muster all resources required to effectively respond. The system and methods of the invention could also allow remote monitoring in other environments, such as to personally monitor property or the like. The devices can be networked to monitor other camera locations that are connected to the network.

Environments in which it is believed that device of the present invention will have applications include the home, commercial and industrial establishments, law enforcement agencies and the military.

### BRIEF DESCRIPTION OF THE DRAWINGS

FIG. 1 provides a perspective view of the portable, hand-held security device of the present invention.

FIG. 2 shows a block diagram of an alternate embodiment of the invention.

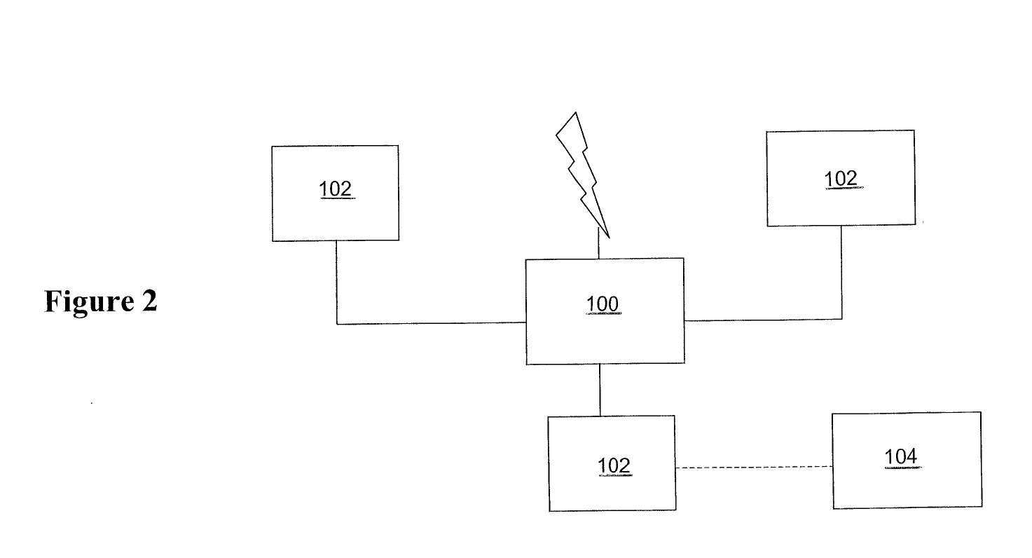

FIG. 3 is a block diagram of the power distribution in the device according to an embodiment of the invention.

FIG. 4 is a plan view of the graphical user interface of an embodiment of the present invention.

### DETAILED DESCRIPTION OF THE PREFERRED EMBODIMENT

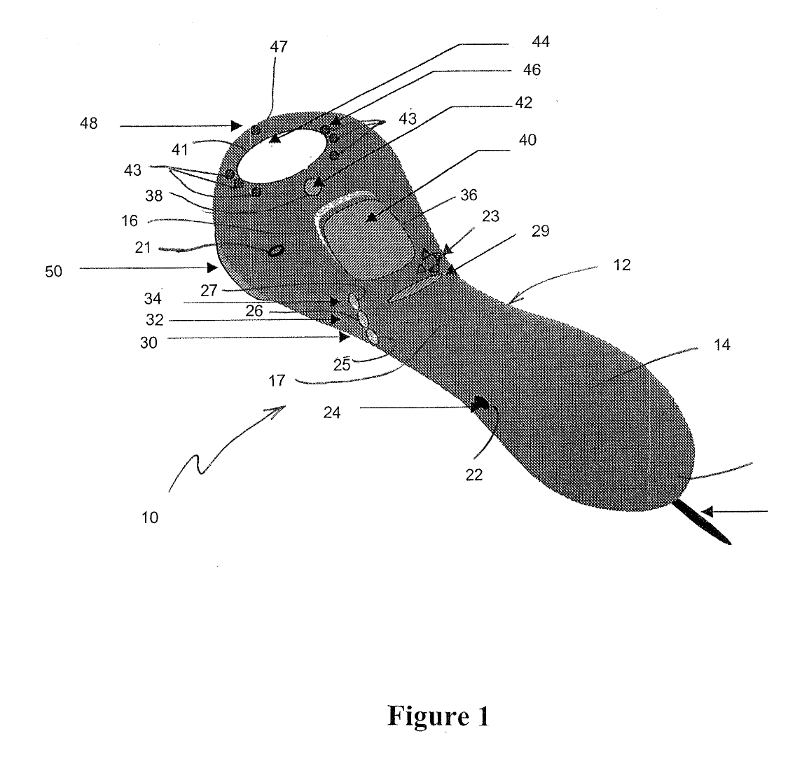

A portable, hand-held security device in accordance with a preferred embodiment of the present invention is shown generally by the reference number 10 in FIG. 1. The device 10 is comprised of an ergonomically contoured outer housing 12 which may be fabricated from any of a number of known, high strength, light weight, moldable plastic substances, or any of a number of other suitable substances. The outer housing 12 is generally elongated and may comprise a handle portion 14 and a head portion 16.

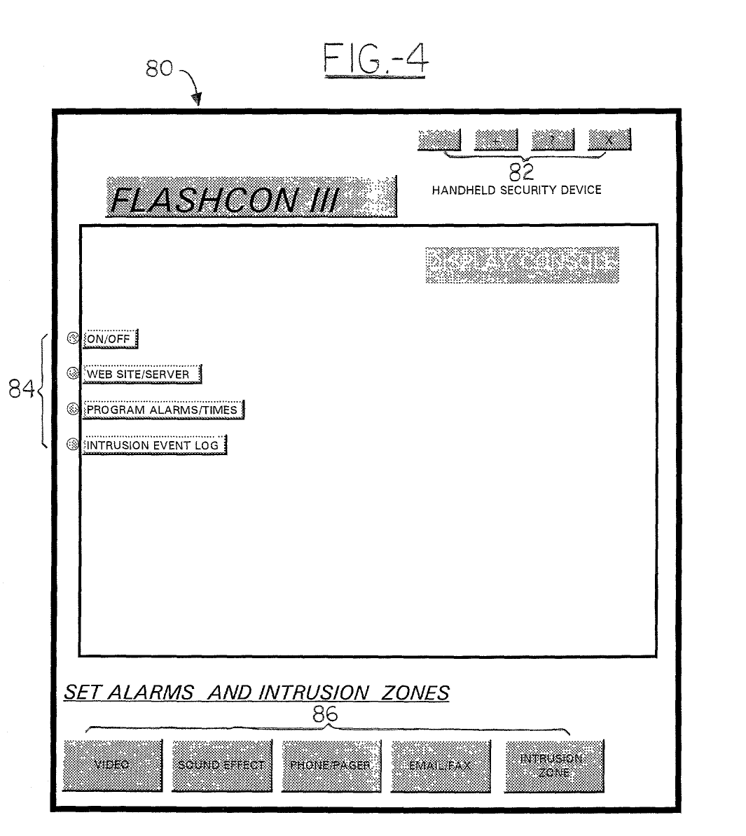

As shown in FIG. 1, the handle portion 14 may be provided with a relatively slim neck 17 at the midsection of the housing 12 so that the housing 12 may be easily and securely grasped by the hand of its user. This also facilitates use of the various functions available on the unit 10. The handle portion 14 is provided with a plurality of user interfaces generally shown at 23, to facilitate operation of various functions. The interfaces 23 may include buttons or switches to activate certain operations, or could include cursor controls or a mouse pad to allow screen editing or control of functions on the video display 40 via a CPU or other processor. As an example, the unit 10 could be provided with a miniaturized PC on-board to allow significantly more functionality. There are known single chip PC's, such as the MachZ made by ZF Linux Devices, Inc., which provides a CPU, with BIOS, OS and boot Rom on a chip. The embedded PC would allow the use of a graphical user interface (GUI), such as shown in FIG. 4. The GUI generally indicated at 80 may be displayed on the display 40 upon power up of the unit 10. Various user control buttons 82 are displayed for navigating through menus on the GUI 80. Various control functions 84 may also be provided for initiating functions and operating the unit 10. It is noted that the functions 84 may include an On/Off button, a Web Site/Server button to initiate communication with the web site/server at a remote location, a Program Alarms/Times button to allow setting of activity alarms or events the user requires knowledge of, as well as an Intrusion Event Log button to allow storage of information on an on-board memory device or to initiate communication to a central facility for recording and storage or additional activities as needed. The GUI 80 may also comprise operating buttons 86 for various controlling operation of functions such as video capture, setting off an alarm or other sound effect, initiating audio communications or pager type functions, initiating email/fax operations from the unit 10 or monitoring via the display a plurality of intrusion zones being monitored by other units 10 or other monitoring systems. It should be recognized that other functionalities may also be presented and controlled via the GUI in embodiments of the invention.

An antenna 20 is provided either externally as shown, such as projecting outward from the end 18 of housing 12, or internally within housing 12. The antenna 20 is connected with a communications system, preferably a wireless system such as a radio frequency (RF) transceiver or ultra wide band (UWB) communication system housed within the housing 12. The communication system permits the sending and receiving of audio and/or video signals between the device 10 and a remotely located network operating or command control center, or other units 10 as desired. Any other suitable communication system is contemplated, such as cellular or the like, wherein audio or video information may be converted for transmission via cellular phone networks or as TCP/IP packets. In the preferred form, the communication system allows wireless communication, to again enable portable use of unit 10. In the preferred embodiment, the RF or other wireless communications may be interfaced with a computer at the network operating center or other location to record, store or otherwise process information received or transmitted. It is also contemplated that the communications system may allow a wireless communication link to unit 10 to operate through an Internet web site. In this manner, a user could remotely view information collected by a unit 10 on the web site via a personal computer or the like. Similarly, the device 10 may communicate with the Web Site to access data or other information which may be useful to the user. For example, the user could access background information on a suspect apprehended in a security system or the like. The unlimited access to any information available on the Internet remotely on the device 10 could be useful for many purposes. Secure transmissions may be made using encoding techniques or the like to provide a secure communications network. Wireless communication from the unit 10 may be dedicated or provided through any suitable wireless network via a wireless application service provider (“WASP”) for example.

The unit 10 may also be provided with an audio/video transmit switch 24. The transmit switch 24 is also electrically connected to the radio-frequency transceiver apparatus and a microphone 21 and enables the user of the device 10 to transmit audio signals to the control center or other device 10 by simply activating the switch 24 by the touch of a finger. The unit 10 thus operates similar to a walkie talkie type of apparatus with respect to audio communications. The radio-frequency transmitter-receiver apparatus is operable at any desired frequency, and allows for secure transmissions. Other wireless communication systems could be configured to provide desired audio communication to a control center, other unit 10 or wireless network.

The unit 10 may also be provided on its upper surface with an ON/OFF switch 29 which is electrically connected to an electric power source housed within the housing 12. The power source preferably will be a battery, however, other suitable power sources may also be employed. An infrared switch 30 may also be provided, which is operatively connected to an infrared radiation generator, which may comprise a plurality of IR LED's 43 provided on the head portion 16. The infrared switch 30 enables the user of the device 10 to selectively activate and deactivate the infrared radiation generator. The IR generator may be used to illuminate objects with IR radiation and to use an IR detecting video camera to allow the device to “see” in the dark or under low illumination. A camera switch 32 permits activation and deactivation of a miniature video camera 42, which may be positioned at a front part of the housing 12. A flashlight switch 34 is electrically connected to a conventional light source to emit light from a front part of housing 12 through lens 44, to permit the user of the device 10 to turn the flashlight apparatus on and off as desired.

A liquid crystal display monitor 40 or other suitable display, may be housed with the housing 12, to allow communication with the user and/or viewing camera input or a communications from the network operating center, another device 10 or a wireless network. The display monitor 40 may be associated with a video module, also contained within the housing 12, used to send video images to the control center or other device 10, etc. The display monitor allows 40 the user of the device 10 to view video images produced by the camera and transmitted by wireless transmission or to receive and display other signals or data. In the preferred embodiment of the present invention, the size of the display monitor is 1.8 inches. The monitor may be a color TFT LCD element having a resolution of 480×234 pixels, a 6 o'clock viewing angle and a dot pitch of 0.076×0.117 mm. Additionally, a suitable video module is a NTSC/PAL video system with RGB Delta configuration and H: 15.75 kHz, V: 60 Hz and C: 3.58 MHz. A suitable RF transceiver module for use in the invention may be a P3 Watchguard wireless RF module produced by the Fels Company. The RF module preferably allows networking with several units 10, and may include multi-channel operation for assigning various units 10 a particular communication frequency. Digital wireless communications systems usable in the invention would allow similar capabilities. Upon turning unit 10 on, it may be configured to be network connected to a monitoring or security network of a plurality of units 10, or simply a network of monitoring stations which could include fixed video and/or audio monitoring devices. In this manner, for use in a security system, a user with a remote, portable unit 10 can effectively communicate and access information produced by other units 10, from monitoring stations or from Internet resources. Additionally, the video module in device 10 may be configured to allow motion detection, wherein the video transmission from unit 10 may be automatically initiated upon detecting motion within its field of view.

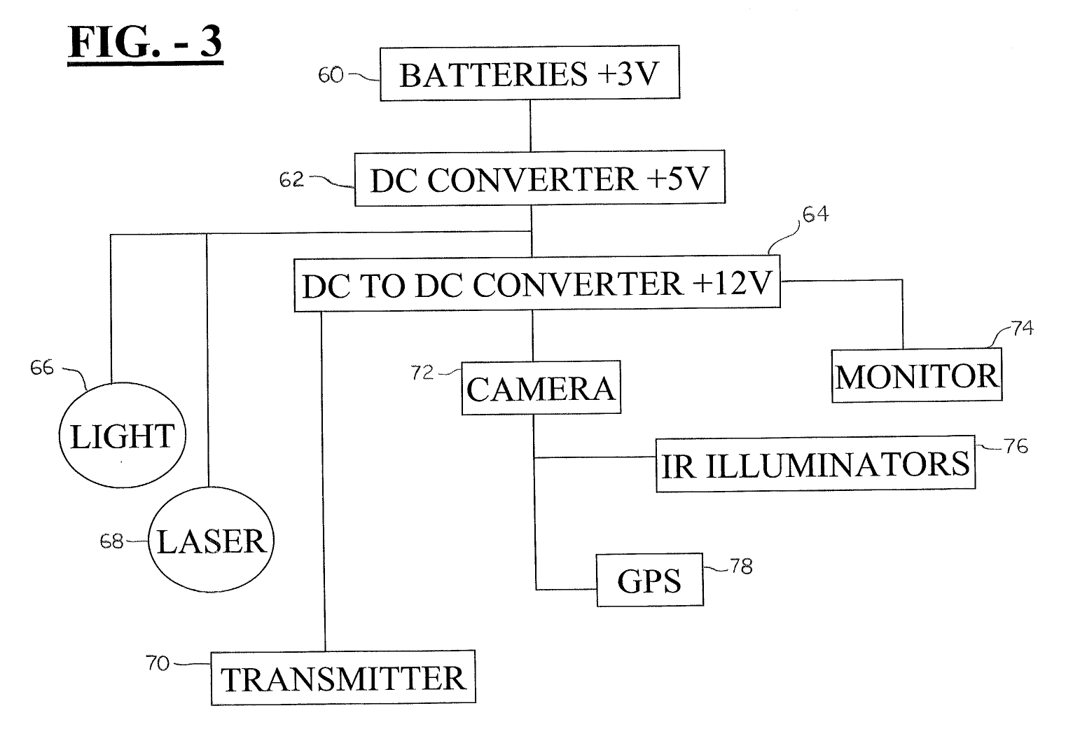

The device 10 may also be provided with other functional devices as desired. For example, in conjunction with camera 42, there may be provided a changeable lens operatively connected to camera 42 to vary the viewing parameters of the camera. In the preferred form, the overall size of the camera is 0.3 in.×0.3 in., and has a visual range of up to 1000 ft. The camera 42 is operated with a suitable voltage supply, which may simply be two 1.5-volt batteries. The power supply will operate all electrical components in the device. As shown in FIG. 3, the power requirements for various components in the system may be supplied by at least one battery to allow the device to operate as a hand-held, portable device. In FIG. 3, the battery power supply may simply as two 1.5-Volt batteries or other suitable supply voltage 60 housed in the device. The power supply may then be coupled to a DC converter 62 to increase the voltage to a predetermined value, such as 5 volts or another supply voltage. If other supply voltages are needed to operate certain components in the system, the DC converter 62 may be coupled to a DC to DC converter 64, to increase the supply voltage from the power supply to a further value, such as 12 volts. In an embodiment of the invention, a 12-volt supply voltage will be sufficient to operate all components in the system. Power is then supplied to the various components, such as the light source 66, the laser source 68, the transceiver 70, the video camera 72, the display monitor 74, the IR illuminators 76 and/or GPS 78 as examples. The power supply will allow the associated wireless communication system to transmit video images and/or audio to a remote site or another unit as desired.

As mentioned previously, there may be a plurality of IR LED's 43 provided leftwardly and rightwardly of the flashlight lens orifice 41. Each LED illuminator 43 is operative to emit infrared radiation upon is activation of the infrared switch 30 in the handle 14. The LED illuminators 46 will be used in dark surroundings to enable the camera system, which is provided with night vision capabilities, to receive, via the camera lens 42, infrared radiation reflected from objects and/or persons in the path of the emitted radiation. Infrared images of the surroundings, formed by the camera, may then be electronically relayed to the radio frequency transmitter/receiver unit, and they are sent via radio signal from the antenna 20 to the control center for viewing by the center operator, another user of a device 10, or at another location, such as by a compatible system in a police car or the like.

There may also be provided a laser unit enclosed within the housing 12, and may be PLL crystal controlled for enhancing proper communication of the image information. The laser unit 47 may be used to emit a focussed beam of visible light to facilitate targeting objects or views with the video system. The laser may be coupled to operation of the video system, allowing zooming or other functions based upon the target location of the laser light. Alternatively, the laser could be used to direct at an intruder as a distraction or safety measure. The laser source could also be modulated to transmit information to a suitable detector, such as to download data from unit 10 or to otherwise communicate information from unit 10.

Further, other defensive or offensive safety precautions can be built into device 10 to facilitate use in the contemplated environments. For example, a global positioning system (GPS) transmitter may be provided in housing 12 to allow accurate locating of the position of device 10. There may also be provided one or more self-defense or safety features built in, such as a pepper spray or like dispenser with a spray outlet 50 which is operatively linked to a reservoir containing a powerful irritant. In the preferred embodiment of the invention, the reservoir is a gas-filled cartridge and the irritant contained therein is hot pepper gas. The hot pepper gas as well as the propelling medium is non-toxic and non-flammable, and neither the pepper gas nor the propellant will deplete the earth's ozone layer. A cartridge with the gas or other fluid to be dispensed is readily replaceable and contains approximately 12 gram 10% pepper spray.

The laser unit and the pepper spray storage and dispensing mechanism cooperatively operate as a self defense means which enables the user of the device 10 to temporarily incapacitate an intruder such as a burglar or a person posing a threat of bodily injury and/or death. When a need arises to employ the device 10 for self defense purposes, the user simply activates the laser unit, points the beam of laser light emitted from the end 48 toward the assailant and releases a quantity of the pepper gas through the spray outlet 50. When the pepper gas is released in a dark or lowly lighted area, the gas, as it travels toward the assailant, appears to be riding on the laser beam. This phenomenon plus the presence of the laser beam tend to have an immediate and adversely profound psychological effect on the assailant, unnerving that person and causing him or her to think that he or she is in harm's way other self defense or like mechanisms may also be provided as desired.

Typically, the pepper spray storage and dispensing mechanism of the present invention provides approximately ten sprays per cartridge and has a dispensing range of up to ten feet from the outlet 50. Additionally, the debilitating effects of the pepper spray lasts for up to 30 minutes, with the result that the user of the device 10 is able to better handle a situation and summon help while the assailant is suffering the effects of the spray if needed.

In a commercial or industrial setting, the device 10 of the present invention is very well suited for use by security and safety guards during mobile and/or on-foot patrol tours of buildings, grounds or the like. The device 10 can be used by the guards to uncover and report the existence of hazardous conditions on the premises. Among such conditions might be broken containers and spilled substances which might cause injury giving rise to insurance claims. In such instances, the guard can quickly provide the control center with an audio and/or video description of the condition and the operator of the control center can, if he or she deems appropriate, make audio and/or video recordings of the transmission for insurance and other purposes and arrange warnings to be posted in the affected area and for the hazard to be removed. It is envisioned that when such reports are made to the control center, especially in the form of video images, the camera employed with the device of the present invention will provide with the image the time and date of transmission so that such information can also be made a part of any recording made at the control center.

In a residential setting, it is envisioned that the present invention will be applied in a somewhat modified manner. A device according to this embodiment would centrally locate the control and transmitting system 100 within a house as an example, which could then be linked to one or more cameras 102 and telephone lines at the dwelling. A camera may be mounted somewhere in the interior of the dwelling, e.g., on a wall facing a window or an entryway, or may be installed within a conventional viewing or “peep” hole of a door, or other location. In first instance, the home owner, acting in much the same way as a security guard, can activate the camera via a hand-held device 104 resembling a remote control device used with television sets, radios and VCR's. The home owner operates the remote control 104 to send a signal to the control system 100 and the system 100 then communicates via conventional telephone service or wireless communication with the control center which will be situated off site and function very much like monitoring centers that monitor conventional home security systems. In addition, with such a system, typical devices such as an electrical contact switch may be provided in a door or window, and when an intruder opens the door or window, the switch becomes opened, causing the black box to telephonically communicate with the control center. It is envisioned that the control center can be linked to local emergency services such as 911, which can dispatch appropriate aid to the residence from which the alarm was received.

In a law enforcement setting, it is envisioned that audio and video signals transmitted and received from devices of the present invention, whether the devices are being employed in commercial, industrial or residential locations, can be relayed by the control center to video receiving equipment on police vehicles or the like, so that vehicle occupants enroute to a trouble site can see first-hand the conditions at the site, and have an opportunity to be better ready to deal with the situation upon arrival. The information, whether video or audio or both, may also be communicated to other units 10 in a similar manner. A security system

In the case of military use of the device of the present invention, it is further envisioned that satellite linkage between the device 10 can also be included so that tracking of one or more of the devices 10 may be accomplished and so that information relayed by one or more of the devices linked to the control center can also be provided to other combat units for deployment purposes.

Although the present invention has been described above in detail, the same is by way of illustration and example only and is not to be taken as a limitation on the present invention.

What is claimed is:

1. A security device comprising,
a housing,
a video module in the housing for generating video images, and
a communication system coupled to the video module for transmission of the video images to a remote location.

2. The device according to claim 1, wherein the housing a hand-held, portable housing.

3. The device according to claim 1, wherein the communication system includes an RF transceiver module for wireless communication with another RF transceiver at the remote location.

4. The device according to claim 1, wherein the communication system both transmits and receives video images, and the device further comprises a display associated with the housing for viewing received video images.

5. The device according to claim 1, wherein the communication system comprises an ultra wide band communication module.

6. The device according to claim 1, further comprising an audio transceiver to receive and transmit audio information.

7. The device according to claim 1, further comprising a light source associated with the housing, which is selectively actuated to produce illuminating light.

8. The device according to claim 7, wherein the illuminating light is visible light.

9. The device according to claim 7, wherein the illuminating light is IR light.

10. The device according to claim 1, further comprising a laser source for producing a laser beam which is selectively directed at a target.

11. The device according to claim 1, further comprising a locating system associated with the housing for producing information relating to the position thereof.

12. The device according to claim 1, further comprising a material dispensing system for storing and selectively dispensing a predetermined material.

13. The device according to claim 12, wherein the predetermined material is a substance for providing personal protection against another person.

14. The device according to claim 1, further comprising a CPU associated with the housing for controlling operation of functions of the device.

15. A security device comprising,
a housing,
a video module in the housing for generating video images and
a light source selectively actuated to produce illuminating light.

16. The device according to claim 15, wherein the light source is selected from the group consisting of visible light sources and infrared light sources.

17. The device according to claim 15, further comprising an audio transceiver to receive and transmit audio information.

18. The device according to claim 15, further comprising a communication system coupled to the video module for transmission of the video images to a remote location.

19. A method of providing security or monitoring of an area comprising the steps of:
providing at least one security device comprising a housing having a video module provided therein for generating video images and a communication system coupled to the video module for transmission of the video images,
providing a network operating center having a communication system for receipt of video images transmitted from the at least one security device for viewing of the video images at the remote location of the network operating center.

20. The method according to claim 19, wherein the network operating center wirelessly communicates with the at least one security device.

21. The method according to claim 19, wherein the network operating center upon receipt of transmitted video images from the at least one security device, can retransmit the video images.

22. A monitoring device comprising,
a housing,
a video module in the housing for generating video images,
an audio transceiver to receive and transmit audio information and
a communication system coupled to the video module and audio transceiver for transmission of video and audio to a remote location.
